(19) United States
(12) Patent Application Publication
(10) Pub. No.: US 2011/0179477 A1
(43) Pub. Date: Jul. 21, 2011

(54) SYSTEM INCLUDING PROPERTY-BASED WEIGHTED TRUST SCORE APPLICATION TOKENS FOR ACCESS CONTROL AND RELATED METHODS

(75) Inventors: W. Wyatt Starnes, Portland, OR (US); Srinivas Kumar, Cupertino, CA (US)

(73) Assignee: Harris Corporation, Melbourne, FL (US)

(21) Appl. No.: 12/982,528

(22) Filed: Dec. 30, 2010

Related U.S. Application Data
(63) Continuation-in-part of application No. 11/608,742, filed on Dec. 8, 2006.
(60) Provisional application No. 60/749,368, filed on Dec. 9, 2005.
(60) Provisional application No. 60/759,742, filed on Jan. 17, 2006.

(51) Int. Cl. H04L 9/32

(52) U.S. Cl. 726/9

(57) ABSTRACT

A target device may have a target application and a web application thereon, and a trust broker may generate an application token having associated therewith a state attribute having at least one of a hash digest and a property value assertion, and weighted trust score. The application token may correspond to a level of trustworthiness, in near real time, of a running application instance of the target application. A trust monitor may monitor an execution state of the target application, and an authentication broker may authenticate a user to the web application and based upon a web services query for remote verification of the target application. A network access enforcer may control access of an authenticated user to the target application, and a trust evaluation server may interrogate the target application and generate a trust score.

### RELATED APPLICATIONS

This application is a continuation-in-part of U.S. patent application Ser. No. 11/608,742, entitled “METHOD TO VERIFY THE INTEGRITY OF COMPONENTS ON A TRUSTED PLATFORM USING INTEGRITY DATABASE SERVICES,” filed Dec. 8, 2006, the entire subject matter of which is incorporated herein by reference in its entirety.

### FIELD OF THE INVENTION

The present invention relates to the field of computers and, more particularly, to computer networking and related methods.

### BACKGROUND OF THE INVENTION

In today's virtualized utility model cloud computing ecosystem, it may be difficult for clients (users or application software) of a particular service, business process, device, or application, whether web based front-end portals or non-web based back-end applications devices or services, to know with any degree of assurance whether an accessed application package and runtime posture is trustworthy. This often leads to blind or assumed trust on the part of the client. A lack of trust can also dissuade users from completing a transaction or to provide secret credentials such as passwords, personal identification numbers (PINs), or key FOB codes to the target service, device or application because of fears of unknown configurations, security hazards, computer viruses, server bots, advanced persistent threats (APTs), or other threats associated with delegated and/or impersonation of acquired credentials.

Security mechanisms implemented today, such as secure socket layer (SSL) certificates (which generally serve to prove the identity of machines) and Kerberos tickets (which generally serve to prove the identity of users) typically lack a continuously measured trust mechanism to reflect a real time integrity, security and configuration evaluation of applications, services and devices utilized for the transaction. Accordingly, a need remains for a way to identify, measure and attest active components of an application package and/or business service on a target platform on a continuous, for example, a real or near real time, basis, to ensure that the proper state exists before a transaction or event occurs.

### SUMMARY OF THE INVENTION

In view of the foregoing background, it is therefore an object of the present invention to measure and attest active components of an application package and/or business service on a target platform, as well as the platform itself, on a continuous basis to ensure that they are in at a threshold level of minimum attestable trust before a transaction occurs.

This and other objects, features, and advantages in accordance with the present invention are provided by a system that includes a target device having a target application and/or a web application thereon. The system also includes a trust broker configured to generate an application token having associated therewith a state attribute comprising at least one of a hash digest and a property value assertion, and weighted trust score. The application token corresponds to a level of trustworthiness, measured on a continuous basis, of a running application and/or business service instance of the target application on the target device.

A trust monitor is configured to continuously monitor the security, configuration and/or integrity state of target, business service, and application(s). The system includes a trust broker configured to authenticate a user to the web application, device or business services, based upon a web services query for remote verification and/or attestation of the trust state of the target device, application, or business service. The system may also include a network access enforcer, or a linkage to an existing network access enforcer, configured to control and/or enable access of an authenticated user to the target application, etc., and a trust score evaluation server configured to interrogate the plurality of applications and overall device or business process integrity and security posture based upon a request for a trust score, and generate the trust score based upon the scope of that interrogation.

The application token may include at least one of a registered service principle name for the running application instance, active listening and open port information, a product publisher, and product version information. The trust broker may be configured to generate a new trust token based upon a state change in the running application or business service state and instance. The new application token may include the weighted trust scores and one of several property value assertions.

The application token may include a digitally signed token. The trust authentication broker may include a security token service (STS), for example. Also the network access enforcer may be configured as a policy enforcement point (PEP) to enable access or gating based on the trust score token received.

A method aspect is directed to a method for evaluating integrity of a web application, device, and/or business services. The method includes requesting a token for a web application instance, and initiating an interrogation of the web application, device and/or business process instance on a web services enabled machine based upon an access or transaction request. The method also includes establishing a secure channel between the web services enabled machine and a trust broker server, and generating at least one digest corresponding to at least one element of the web application and/or business service instance. The method further includes generating a security, compliance, and integrity report to include the at least one digest, and transmitting the integrity report to a trust authentication broker. The method also includes generating weighted trust scores and property value assertions based upon the security, compliance, and integrity report, transmitting the weighted trust scores in the token to the authentication broker, and including the weighted trust scores of the web application instance as a logo on a user web browser.

Another method aspect is directed to a method for interrogating a target device, application and/or business service. The method includes generating a token for a target application using a trust broker server, requesting an interrogation of the target device, application and/or business service, and for requesting or subscribing to a notification of any state change of the target device, application and/or business service. The method also includes receiving weighted trust scores and property value assertions of the target device, application and/or business service based upon at least one of the interrogation and/or subscription notification requests. The method further includes including the weighted trust scores and property value assertions into the token, and providing the token to at least one of a trust authentication broker and a network access enforcer.

### BRIEF DESCRIPTION OF THE DRAWINGS

FIG. 1 schematically illustrates architecture of a trust broker including running target applications and a trust monitor, according to an embodiment of the present invention.

FIG. 2 is an operational flow diagram of the procedure used to dynamically monitor and verify the state of the running target application of FIG. 1, according to an embodiment of the present invention.

FIG. 3 schematically illustrates a web application and an authentication broker (client) with a trust broker and an application token, according to an embodiment of the present invention.

FIG. 4 schematically illustrates a network access enforcer (client) with a trust broker and application tokens, according to an embodiment of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Generally speaking, a system according to an embodiment includes a trust monitor to discover running target applications, a trust broker to receive a request to attest the trustworthiness of a running target application, and query a trust evaluation server to receive reports and metrics of attributes based property value assertions (PVAs) about the running target application. The system is configured to generate a one-time application token which includes assertions about the running target application, and to deliver the token to the requestor. A trust scoring system is configured to perform continuous monitoring to measure and verify the state (binary hashes and configured startup and runtime properties of packaged components of the target application), and provide verification reports and metrics responsive to the query.

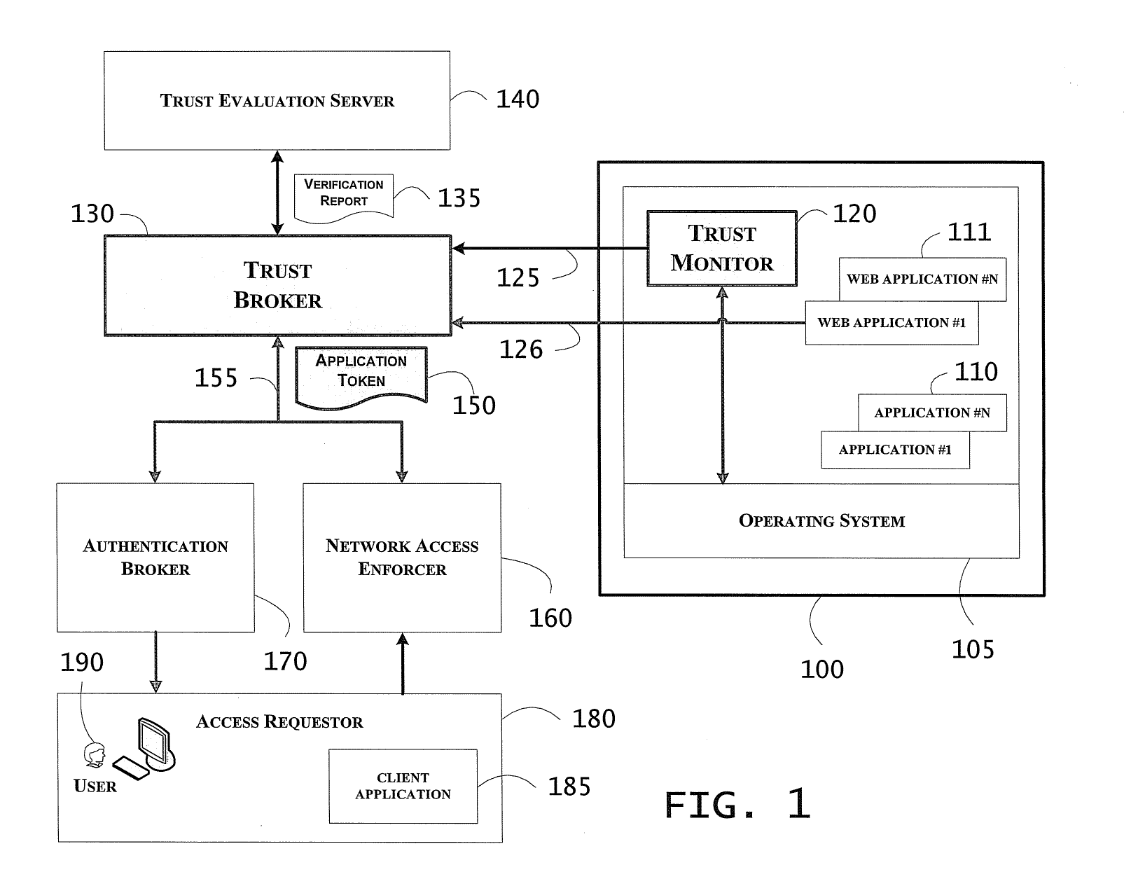

Referring initially to FIG. 1, to address the problems in the prior art, an embodiment begins by setting forth a method and system for a trust broker service which issues application tokens to evaluated running applications. A trust requestor (e.g., network access enforcer, network security device, authentication broker, network router, etc.) can request a score-evaluation from the trust broker service, and is, in turn, evaluated by one or more trust evaluation servers belonging to a trust scoring system.

The process of evaluation, among others, involves the collection of digests of files, data elements and properties (as requested by the trust evaluation servers) for the running target application on the target machine (or device), and the reporting of these digests and properties in a digitally-signed integrity report to the trust evaluation servers. This process is explained in greater detail in U.S. patent application Ser. No. 11/288,820, filed Nov. 28, 2005, the entire contents of which are herein incorporated by reference. In summary, based on the digests and property value assertions (PVAs) in the integrity report, the trust evaluation servers can verify each digest and property, to the extent possible, against a signature and reference harvest database (part of the trust scoring system).

As an outcome of the evaluation of the running target application on the target machine by the trust scoring system, the trust broker service issues an application token, which can be digitally-signed, and which includes the globally unique identifier of the application instance together with weighted trust scores assigned to that application instance on that machine (by the trust broker service) and property value assertions of runtime aspects of the application instance. The application identifier can be a publisher designated product name or a registered service principle name in a services directory. The machine identity can be its IP address, X509 device certificate, or other acceptable device identifiers. The weighted trust score is a category based rating of level of concern (LoC). The categories may include vulnerability, compliance, patch level, and reference comparison. Of course, other and any number of categories may be used. The rating for each category is a color coded system, for example, which is an indication of LoC. For example, red may indicated a high risk, orange a mild risk, yellow a low risk, and green for safe. The rating for each category may be configurable by the target device 100 and target application 110 administrators. The ratings are determined by factors that may include verification results, date and time of last verification scans, counts of evaluation tests passed or failed, and positive package identification from an authoritative source for application white-listing based on supply chain provenance. Other factors may be used in determining the ratings.

The application token may be used by web browsers (i.e. passive clients) that can display an application trust attestation logo at the bottom of the web page displayed to the user to provide attestation of application authenticity and trustworthiness. The user that clicks that application trust attestation logo is shown application instance specific trust score information issued (digitally-signed) by the trust broker service for that given target web application, as described below. The consumer may also verify that the application trust attestation offered by the trust broker service is up-to-date. In other words, the consumer may verify that the assertions represent the current state of the target web application. The application token may be used by network access enforcers (e.g. firewalls), authentication brokers (e.g. security token service (STS) and active clients (e.g. simple authentication and security layer (SASL) applications) to determine near real-time information about the state of a running application on a target machine.

The system in FIG. 1 includes a trust broker service 130, a trust monitor service 120, a trust evaluation server 140, target applications 110, an authentication broker 170, and a network access enforcer 160. Applications running on the Target machine 100, which may be a client laptop/desktop, phone/PDA, network element, type 1 hypervisor, server machine, or other type of machine, are continuously monitored by the trust monitor service 120.

The trust monitor service 120 detects and tracks the start and termination of applications on the operating system 105 platform. The running application's property value assertions (PVAs) are measured at runtime and reported over a secure communications channel to a trust broker service 130. The trust broker service 130 requests a verification report for the running application on the target machine 100 and target platform 105. The trust evaluation server may perform a real time measurement and verification of the target application or lookup the most recent verification test results based on a continuous monitoring schedule and return the verification report to the requestor. The trust broker service 130 generates and returns an application token 150 for the running application as a reference for subsequent real time notification of application state changes by the trust monitor service 120. Any state changes in the running application trigger the interactions to refresh the application token 150.

The authentication broker 170 receives web (HTTP) redirects from web based applications to perform authentication ceremonies to login an interactive user. As part of the web redirect, the web application 111 performs a web services query 126 to the trust broker service 130 to receive an application token 150 and includes the token in the redirect. The authentication broker 150 performs a web services query 155 to validate the received application token 150 with the trust broker service 130 to establish the authenticity of the running application. A visual indication of application trust is provided to an access requestor 180. An interactive user 190 receives the visual attestation of application trust, for example, as a logo on the web login form, and either accepts or rejects the assertion before proceeding with any interaction with the target web application 111.

A network access enforcer 160 may subscribe with the trust broker service 130 for application tokens 150 to enumerate running (non-web) applications 110 in one or more target machines 100. The communications between the trust broker service 130 and the network access enforcer 160 may be a standards based protocol and message exchange, such as, Trusted Computing Group's (TCG's) Interface for Metadata Access Points (IF-MAP) specification or a web services query 155. Of course, other standards may be used. The trust broker service 130 publishes notifications with near real-time application tokens for the network access enforcer 160 to apply access controls based on transport level property value assertions (PVAs) in application tokens 150 that include static (well known) and dynamic (ephemeral) service ports attributed to running (non web) applications 110. A client application 185 and a server application 110 using the simple authentication and security layer (SASL) protocol may use the application token programmatically in a mutual trust handshake defined by an integrity exchange profile, before initiating an authentication handshake with proof of possession of credentials.

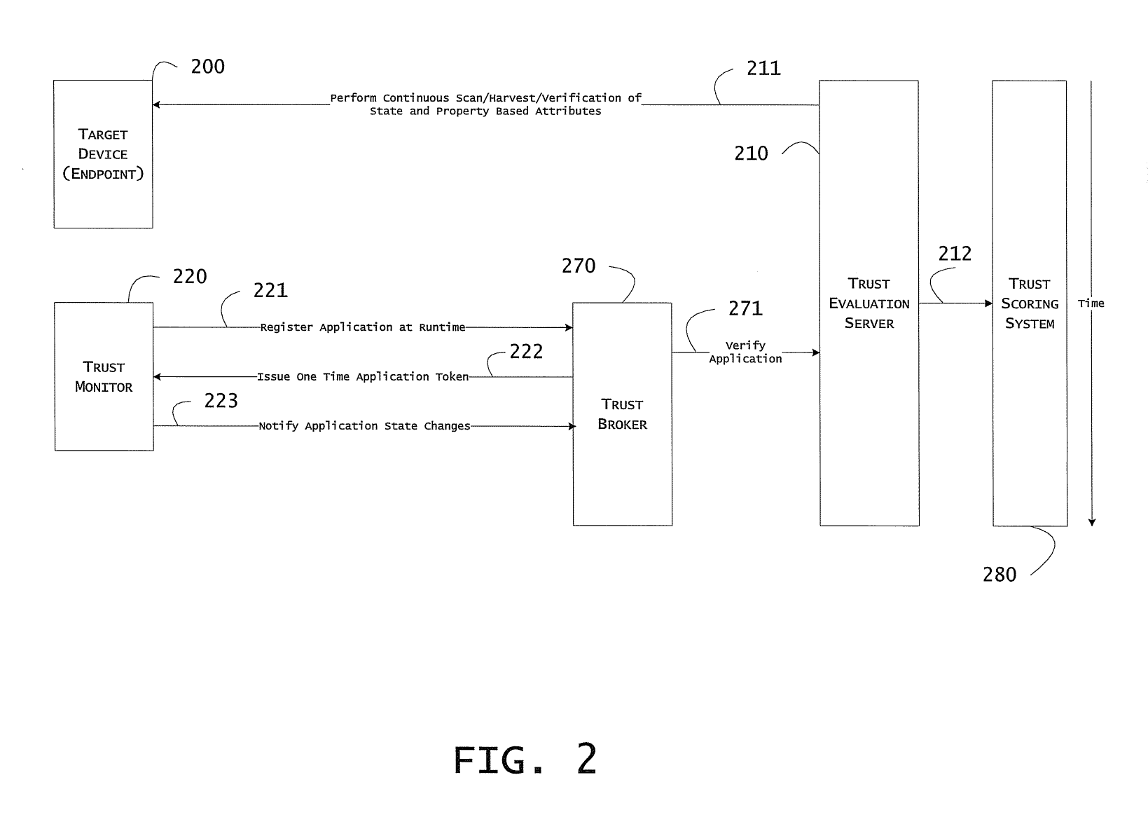

Referring now to FIG. 2, a system including a trust broker service 270, a trust monitor service 220, a trust evaluation server 210, a trust scoring system 280, and a target device 200 according to an embodiment is illustrated. All applications running on the target device 200 are objects that are continuously monitored by the trust monitor service 220 and measured and verified by the trust evaluation server 210 for trustworthiness.

The trust evaluation server 210 performs continuous state monitoring 211 of the target device 200 based on a schedule to scan and verify the state of the running applications (binary hashes and properties of all application package components) against checklists (e.g. extensible configuration checklist description format (XCCDF), open vulnerability and assessment language (OVAL)). A harvest operation performed on the target device 200 provides a local reference of applications states to measure deviations over a time period. The protocols and message exchanges for state monitoring 211 between the trust evaluation server 210 and the target device 200 leverage instrumentation natively provided by the platform (e.g. windows management instrumentation (WMI) based on distributed management task force (DMTF's) common information model (CIM), management information base (MIBs), and the registry), endpoint resident passive agents, and active endpoint services.

The trust monitor service 220 actively monitors the platform on the target device 200 for application epochs. On detection of application process start, a runtime application profile (metadata), which comprises of at least the file hash digests, product instance specific property value assertions (PVAs) and resources, is generated and the running application instance is registered 221 with the profile with the trust broker service 270. The trust broker service 270 verifies the authenticity of the running application on the target device 200 with a near real time exchange of the metadata 271 with a trust evaluation server 210 which communicates and receives product manifests and catalogs feeds 212 from a trust scoring system 280, and records of most recent measurements and verifications on the target device 200.

The trust scoring system 280 leverages product metadata content feeds through a supply chain distribution channel for provenance and a cache of local harvests and contexts to identity the running application on the target device 200 with positive assurance of authenticity. The trust broker service 270 generates a globally unique time-locked one-time application token 222 and returns the token to the trust monitor service 220. The trust monitor service 220 continuously monitors the running applications instances for state changes, including, for example, runtime configuration settings, active listening ports at the transport layer of the open systems interconnection (OSI) stack, and terminations of the applications. Other types of state changes may be monitored. Any state changes are notified in near real time 223 to the trust broker service 270. The trust broker service 270 stores persistent and transient state metadata in a local database or remote repository (such as an IF-MAP Server) for all registered running applications instances on the target device 200.

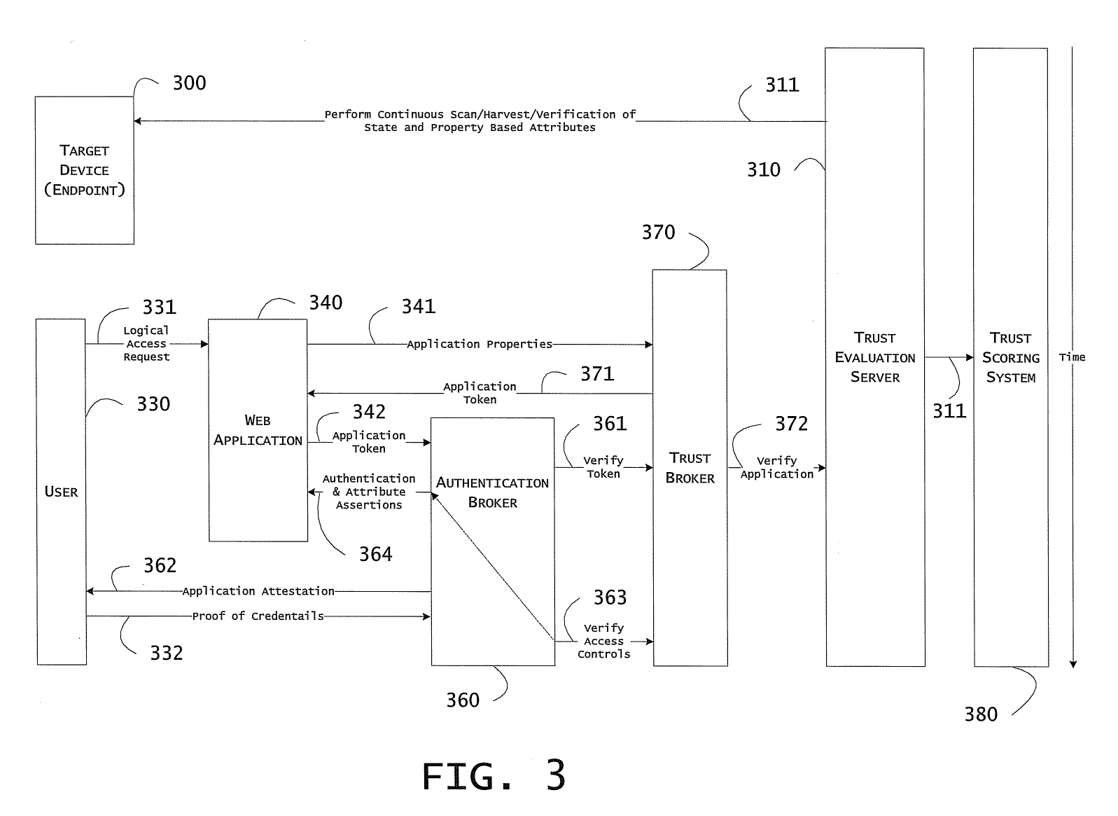

Referring now to FIG. 3, a system including a trust broker service 370, a trust evaluation Server 310, a target device 300, an interactive user 330, a web application 340, an authentication broker 360, and a trust scoring system 380, according to an embodiment is illustrated. All web applications 340 running on the target device 300 are objects that leverage the trust broker service 370 for remote attestation of the trustworthiness of the web application 340 instance at runtime. The operational flow is an exemplary embodiment of the procedure to enforce, at the post-connect phase of a session, logical access control at an intermediate system in the flow path without inline appliances.

The trust evaluation server 310 performs continuous state monitoring 311 of the Target Device 300 based on a schedule to scan and verify the state of the running web applications (binary hashes and properties of all web application package components including scripts and intermediate code elements) against checklists (e.g. XCCDF, OVAL). A harvest operation performed on the target device 300 provides a local reference of web applications states to measure deviations over a time period. The protocols and message exchanges for state monitoring 311 between the trust evaluation server 310 and the target device 300 leverage instrumentation natively provided by the platform (e.g. WMI based on DMTF's CIM, MIBs and registry), endpoint resident passive agents, and active endpoint services.

An interactive user 330 establishes physical access over a network to a target device 300 and requests (logical) access to a web application 340 hosted on the target device 300. The web application 340 executes a code element (e.g. web servlet) that generates a runtime web application profile (metadata), which comprises of at least the file hash digests, product instance specific property value assertions (PVAs) and resources, and performs a web services call 341 to the trust broker service 370 sending the metadata. The trust broker service 370 verifies the authenticity of the running web application instance on the target device 300 with a near real time exchange of the metadata 372 with a trust evaluation server 310 which communicates and receives product manifests and catalogs feeds 311 from a trust scoring system 380, and records of most recent measurements and verifications on the target device 300. The trust scoring system 380 leverages product metadata content feeds through a supply chain distribution channel for provenance and a cache of local harvests and contexts to identity the running web application 340 on the target device 300 with positive assurance of authenticity. The trust broker service 370 generates a globally unique time-locked one-time application token 371 and returns the token to the web application 342.

The web application 340 includes (for example, embeds) the received application token as an assertion in a security assertion markup language (SAML) (or other common form of) token to an authentication broker 360 which uses back-channel communications 371 with the trust broker service 370 to verify and validate the application token and then initiates a direct interactive login sequence with an interactive user 330 in the authentication domain (realm) of the user. The login form (web page) displayed to the user includes a web application trust attestation logo of the authenticity of the accessed web application 340 which is requesting the user's credentials for domain authentication. The logo includes information about the running web application 340 instance, such as, for example, (version, publisher, timestamps, and weighted trust scores. The logo may include other information. The user 330 determines whether the trust scores are acceptable to continue with the transaction and provide credentials to the authentication broker 360.

The authentication broker 360 may query 363 the trust broker service 370 to determine whether logical access to the resource (the web application instance), based on an authorization profile configured for the trust broker service 370, should be granted for the user to access the web application. The authentication broker 360 returns standards based authentication and attribute assertions to the web application 340. The web application provides the user 330 access based on the received authentication and attributes which may include, for example, information about the user's identity, authentication factor (password, PIN, smart card, etc.), and roles, and weighted trust scores for the web application instance in the associated application token. Access may be based upon other attributes. For example, the authentication broker may deny access to an authenticated user based on the level of concern (high) in the weighted trust score for a specific category (compliance) as expressed in user to resource (application) instance policy bindings provisioned for the trust broker service 370. The outcome of the policy decision logic is indicated 364 to the web application.

The authentication broker 360 described here also represents an intermediate single sign on (SSO) entity or function that uses identity vaults to manages passwords to perform authentication ceremonies on behalf of and possibly transparent to the user.

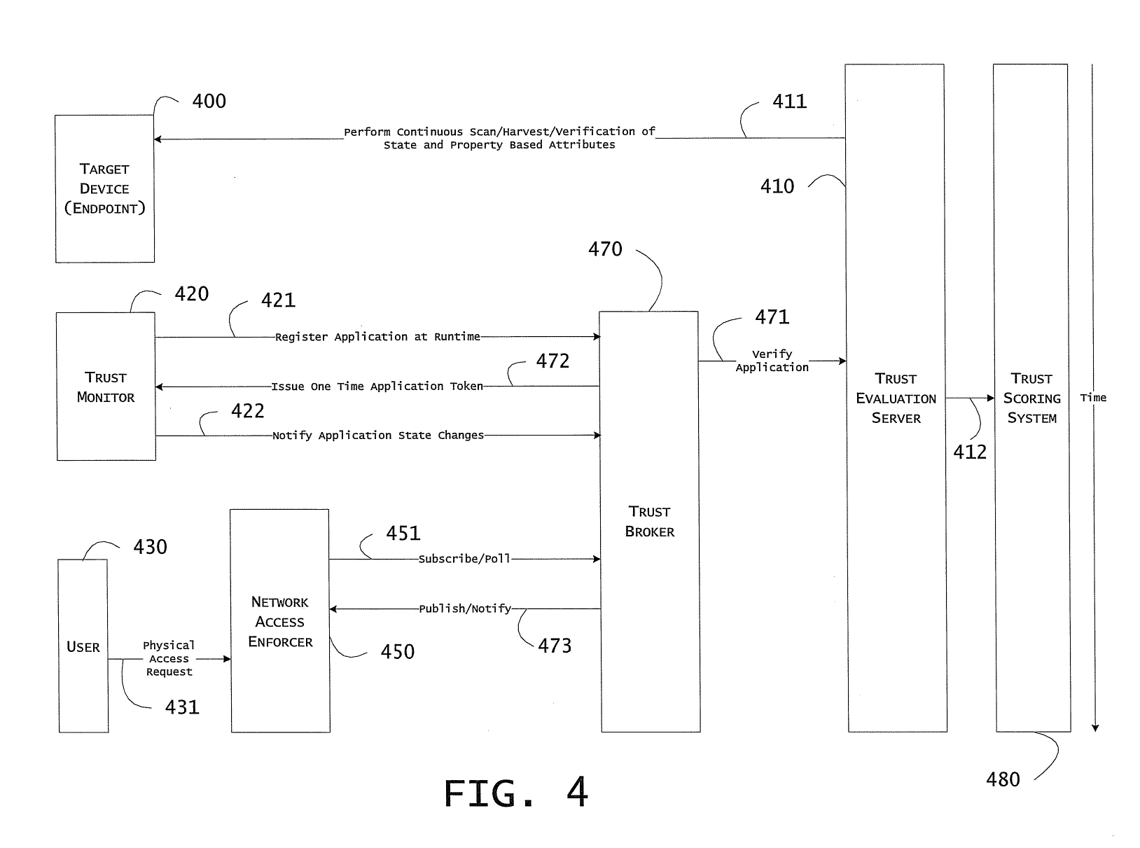

Referring now to FIG. 4, a system including a trust broker service 470, a trust monitor service 420, a trust evaluation server 410, a target device 400, an interactive user 430, a network access enforcer 450, and a trust scoring system 480, according to an embodiment is illustrated. All applications running on the target device 400 are continuously monitored by the trust monitor service 420 for state changes and trustworthiness. The operational flow is an exemplary embodiment of the procedure to enforce, at the pre-connect phase of a session, physical access control at an intermediate system in the flow path.

The trust evaluation server 410 performs continuous state monitoring 411 of the target device 400 based on a schedule to scan and verify the state of the running applications (binary hashes and properties of all application package components including dynamically loadable modules) against checklists (e.g. XCCDF, OVAL). A harvest operation performed on the target device 400 provides a local reference of applications states to measure deviations over a time period. The protocols and message exchanges for state monitoring 411 between the trust evaluation server 410 and the target device 400 leverage instrumentation natively provided by the platform (e.g. WMI based on DMTF's CIM, MIBs, and registry), endpoint resident passive agents, and active endpoint services.

The trust monitor service 420 actively monitors the platform on the target device 400 for application epochs. On detection of application process start, a runtime application profile (metadata), which comprises at least the file hash digests, and product instance specific property value assertions (PVAs) and resources, is generated, and the running application instance is registered 421 with the profile with the trust broker service 470. The trust broker service 470 verifies the authenticity of the running application on the target device 400 with a near real time exchange of the metadata 471 with a trust evaluation server 410, which communicates and receives product manifests and catalogs feeds 412 from a trust scoring system 480, and records of most recent measurements and verifications on the target device 400. The trust scoring system 480 leverages product metadata content feeds through a supply chain distribution channel for provenance and a cache of local harvests and contexts to identity the running application on the target device 400 with positive assurance of authenticity.

The trust broker service 470 generates a globally unique time-locked one-time application token 422 and returns the token to the trust monitor service 420. The trust monitor service 420 continuous monitors the running applications instances for state changes, including, for example, configuration settings, active listening ports at the transport layer of the OSI stack, and terminations of the applications. Other state changes may also be monitored. Any state changes are notified in near real time 423 to the trust broker service 470. The trust broker service 470 stores persistent and transient state metadata in a local database or remote repository (such as an IF-MAP Server) for all registered running applications instances on the target device 400.

A network access enforcer 450 subscribes with the trust broker service over a web services protocol interface 451 for notifications of application tokens for all running applications on the target devices 400. The trust broker service 470 publishes in near real time, up-to-date application tokens 473 to all the subscribers. The application token includes application instance information such as a principle (registered) service name, target device identifier, product identifier, version, weighted trust scores based most recent measurements and verifications performed in accordance with policy templates and scan schedules. The network access enforcer 450 may also query the trust broker service 470 for user specific policy bindings configured for the trust broker service 470 to determine access controls based on application associations and trust metrics based on locally configured risk mitigation mechanisms. For example, the network access enforcer 450, such as a virtual or physical network firewall appliance, may deny access to an authenticated user based on the level of concern (high) in the weighted trust score for a specific category (patch level) as expressed in user to resource (application) instance policy bindings provisioned for the trust broker service 470.

Indeed, it will be appreciated by those skilled in the art that the elements described herein may be included in one or more machines, or be distributed among multiple coupled machines. Typically, such a machine, includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. The term machine may also include one or more a virtual machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, application specific integrated circuits, embedded computers, smart cards, and the like. The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication may use various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The embodiments may also be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system comprising:
a target device having a target application and a web application thereon;
a trust broker configured to generate an application token having associated therewith a state attribute comprising at least one of a hash digest and a property value assertion, and weighted trust score;
the application token corresponding to a level of trustworthiness, in near real time, of a running application instance of the target application on the target device;
a trust monitor configured to monitor an execution state of the target application;
an authentication broker configured to authenticate a user to the web application and based upon a web services query for remote verification of the execution state of the target application;
a network access enforcer configured to control access of an authenticated user to the target application; and
a trust evaluation server configured to interrogate the target application based upon a request for a trust score, and generate the trust score based upon the interrogation.

2. The system according to claim 1, wherein the application token includes at least one of a registered service principle name for the running application instance, active listening and open port information, a product publisher, and product version information.

3. The system according to claim 2, wherein said trust broker is configured to generate a new application token based upon a state change in the running application instance.

4. The system according to claim 3, wherein the new application token includes the weighted trust scores and property value assertions.

5. The system according to claim 1, wherein the application token comprises a digitally signed token.

6. The system according to claim 1, wherein said authentication broker comprises a security token service (STS).

7. The system according to claim 1, wherein said network access enforcer is configured as a policy enforcement point (PEP).

8. A method for evaluating integrity of a web application comprising:
requesting a token for a web application instance;
initiating an interrogation of the web application instance on a web server machine based upon an access request;
establishing a secure channel between the web server machine and a trust broker server;
generating at least one digest corresponding to at least one element of the web application instance;
generating an integrity report to include the at least one digest;
transmitting the integrity report to an authentication broker;
generating weighted trust scores and property value assertions based upon the integrity report;
transmitting the weighted trust scores in the token to the authentication broker; and
including the weighted trust scores of the web application instance as a logo on a user web browser.

9. The method according to claim 8, wherein the integrity report is generated prior to initiating a transaction by a user.

10. The method according to claim 8, wherein the integrity report is generated prior to completing a transaction by a user.

11. The method according to claim 8, further comprising displaying information about the weighted trust scores responsive to a click on the logo.

12. A method for interrogating a target application comprising:
generating a token for a target application using a trust broker server;
requesting an interrogation of the target application;
subscribing for a state change notification of the target application;
receiving weighted trust scores and property value assertions of the target application based upon at least one of the interrogation and subscription;
including the weighted trust scores and property value assertions into the token; and
providing the token to at least one of an authentication broker and a network access enforcer.

13. The method according to claim 12, wherein generating the token comprises generating the token to include at least one of a registered service principle name for a running instance of the target application, active listening and open port information, a product publisher, and product version information.

14. The method according to claim 13, further comprising generating a new token for the target application using the trust broker server based upon a state change in the running instance of the target application instance.

15. The method according to claim 14, wherein generating a new token comprises including the weighted trust scores and property value assertions in the new token.

16. The method according to claim 12, further comprising digitally signing the token.

17. The method according to claim 12, further comprising authenticating the target application using a trust evaluation server and a trust scoring system.

18. The method according to claim 12, further comprising using the token, including the weighted trust scores and property value assertions, to enforce a set of logical post-connect access policies for controlling access to a trusted resource on a network.

19. The method according to claim 12, further comprising using the token, including the weighted trust scores and property value assertions, to enforce a set of physical pre-connect access policies for controlling access to a trusted resource on a network.
